(19) United States
(12) Patent Application Publication
(10) Pub. No.: US 2002/0155851 A1
(43) Pub. Date: Oct. 24, 2002

(54) Mobile communication apparatus

(75) Inventors: Mitsuyoshi Murayama, Tokyo (JP); Yuji Fukumoto, Tokyo (JP)

Correspondence Address: BANNER & WITCOFF, 1001 G STREET N W, SUITE 1100, WASHINGTON, DC, 20001, US

(73) Assignee: Kabushiki Kaisha Toshiba, Tokyo (JP)

(21) Appl. No.: 10/102,020

(22) Filed: Mar. 21, 2002

(30) Foreign Application Priority Data
Mar. 26, 2001 (JP) P2001-88232

(51) Int. Cl. H04B 7/00

(52) U.S. Cl. 455/519; 455/458

(57) ABSTRACT

A communication apparatus is provided that reduces the operating time when a user requests delivery of a message that previously was not delivered. The controller detects when a message is not delivered and registers a group of addresses in a group registering area in a memory. The group of addresses includes addresses of each communication terminal detected that did not receive the message. When the user requests delivery of the message again, the controller sets all addresses included in the registered group as delivery addresses for the message.

### RELATED APPLICATION INFORMATION

This application claims the benefits of priority under 35 U.S.C. § 119 to Japanese patent application No. P2000-88232, filed Mar. 26, 2001, the entire contents of which are incorporated herein by reference.

### FIELD OF THE INVENTION

This, invention is related to a communication apparatus that sends a text, e-mail or voice mail message. The communication apparatus may be, for example, a personal digital assistant (PDA) or a personal computer.

### DESCRIPTION OF THE RELATED ART

Recently, many people have begun to use text message communication services. One existing text message communication service is the short message service (SMS) provided in cellular networks. Many cellular phone network carriers provide a SMS, which many people use.

Some mobile network message services allow a subscriber to send a text message to a plurality of cellular phones simultaneously. When a control station in the network cannot deliver a text message, the user has to select addresses of the intended recipients to which the control station could not deliver the text message for sending the message again. This selecting procedure is cumbersome and can take a long time.

### SUMMARY OF THE INVENTION

The present invention is directed to overcoming the aforementioned problems identified with conventional mobile communication apparatuses. According to one aspect of the invention, a communication apparatus such as a radio communication apparatus is provided in which a user can resend a message with relative ease and in a time efficient manner.

In one aspect of the invention, the communication apparatus may include a memory configured to store a plurality of addresses for delivering a message as a group, and a controller configured to detect the alert message and register addresses detected in the alert message as a group in the memory. Also, the communication apparatus may include a setting unit configured to set the registered addresses as the group of addresses to which the message is delivered.

According to another aspect of the invention, in a communication apparatus such as a radio communication apparatus, a method is provided of setting addresses (e.g., of a destination communication terminal) for delivering a message. The communication apparatus can request a control station in the network associated with the communication apparatus to deliver a message. In another aspect of the invention, the control station sends an alert message to the communication apparatus when the control station cannot deliver a message. The method may include detecting the alert message, registering addresses included in the detected message as a group in a memory which stores a plurality of destination addresses for delivering a message, and setting the registered addresses as the group of addresses to which the message is delivered.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 shows a functional block diagram of an illustrative embodiment of a radio communication apparatus according to the present invention;

FIG. 2 shows an illustrative flowchart depicting an exemplary procedure for setting a registering mode according to the present invention;

FIGS. 3(a) and 3(b) each depict an exemplary image which may be displayed during the procedure of setting the registering mode shown in FIG. 2;

FIG. 4 shows an illustrative procedure of detecting an undelivered-message according to the present invention;

FIGS. 5(a) and 5(b) each show an exemplary image which may be displayed during the illustrative procedure shown in FIG. 4;

FIG. 6 shows an illustrative procedure for registering in a group addresses to which a message could not be delivered according to the present invention;

FIGS. 7(a) and 7(b) show an illustrative data format for registering the addresses to which a message could not be delivered according to the present invention;

FIG. 8 depicts an illustrative procedure for selecting a group address according to the present invention; and

FIG. 9 depicts an illustrative image displayed during the procedure shown in FIG. 8.

### DETAILED DESCRIPTION

Hereafter, an illustrative embodiment of the present invention will be described with reference to the drawings.

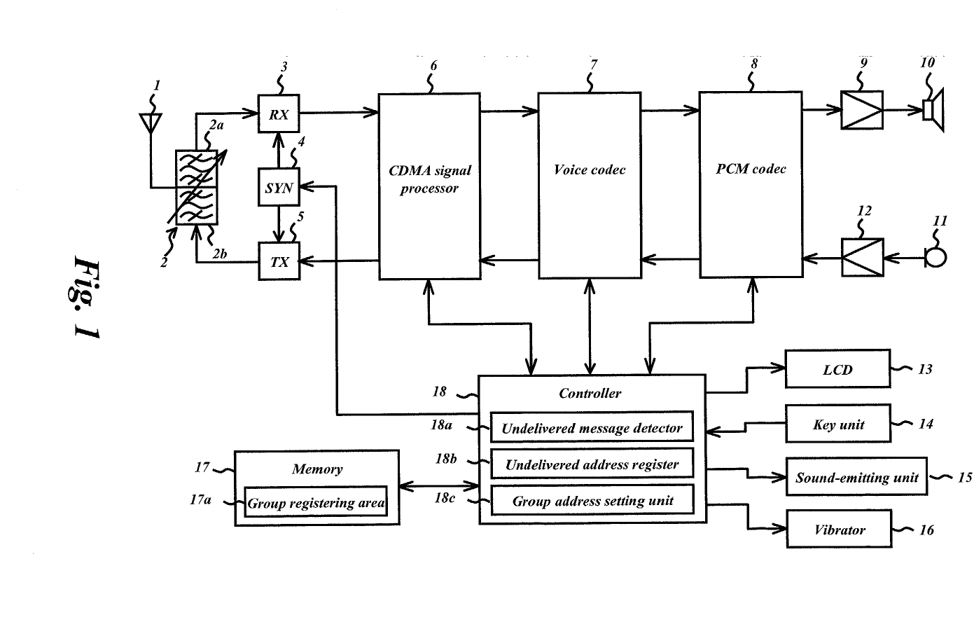

FIG. 1 is a block diagram showing a functional configuration of an illustrative embodiment of a radio communication apparatus according to the present invention.

A radio communication apparatus in this embodiment has an antenna 1, duplexer 2, receiver (RX) 3, frequency synthesizer (SYN) 4, transmitter (TX) 5, code division multiple access (CDMA) signal processor 6, voice codec 7, pulse code modulation (PCM) codec 8, amplifier 9, speaker 10, microphone 11, amplifier 12, liquid crystal display (LCD) 13, key unit 14, sound emitting unit 15, vibrator 16, memory 17 and controller 18.

The antenna 1 receives a radio frequency signal transmitted from a base station over a radio channel. The received signal is inputted to the RX 3 through a filter 2a in the duplexer 2. The duplexer 2 comprises a filter 2a for receiving a signal and a filter 2b for transmitting a signal.

The RX 3 converts the received signal into a frequency signal by mixing a synthesizing signal provided from the SYN 4 with the received signal. A control voltage provided from the controller 18 controls the frequency generated by SYN 4.

The frequency signal converted in the RX 3 is demodulated in the CDMA signal processor 6. Next, the demodulated signal is converted into formatted data in accordance with the data rate by the CDMA signal processor 6.

The processed signal generated by the CDMA signal processor 6 is inputted into the voice codec 7 and the controller 18 as a received data signal.

The voice codec 7 decodes the processed received data signal according to the rate provided by the controller 18. The coded data from the voice codec 7 is inputted into the PCM codec 8.

The PCM codec 8 demodulates the decoded received data signal and generates an analog signal. The amplifier 9 amplifies the generated analog signal, and then inputs the amplified analog signal to the speaker 10. The speaker 10 outputs the amplified analog signal.

When the communication apparatus receives a voice input signal, the voice input signal is converted into an analog signal by the microphone 11. The amplifier 12 amplifies the analog signal. The PCM codec 8 converts the amplified analog signal into a pulse code modulated signal. The pulse code modulated signal is inputted to the voice codec 7 as a transmitting data signal.

The voice codec 7 detects the power of the transmitting voice according to the amplitude of the transmitted data signal provided by the PCM codec 8. The voice codec 7 selects a data rate based on the detected power and informs the controller 18 of the selected data rate.

The voice coded 7 compresses the transmitted data signal and generates a burst signal formatted based on the data rate. The generated burst signal is inputted to the CDMA signal processor 6.

The CDMA signal processor 6 spreads the generated burst signal with a PN code according to the transmitting channel. After spreading the generated burst signal, the CDMA signal processor 6 modulates the spread signal. The modulated signal is inputted into the TX 5.

The TX 5 mixes the modulated signal generated in the CDMA signal processor 6 with a signal generated in the frequency synthesizer SYN 4 to generate a radio frequency signal. The frequency of the radio frequency signal is assigned based on a control voltage generated in the controller 18 and provided to SYN 4.

The TX 5 amplifies the radio frequency signal based on the transmitting data rate provided by the controller 18 and inputs the amplified signal into the duplexer 2.

The transmitting filter 2b selects a radio channel for transmitting the radio frequency signal inputted thereto from the TX 5. Next, the radio frequency signal and the selected radio channel are sent to the antenna 1. Then, the radio frequency signal is transmitted to a base station over the selected radio channel by the antenna.

The LCD 13 that is controlled by the controller 18 displays received text message data in a short message service (SMS) or image. The LCD 13 notifies the user of information or data.

The key unit 14 receives user command inputs such as a telephone number for calling, a key input command for terminating an incoming call, a key input command representing a text character or a key input command for setting information. The user command inputs are sent to the controller 18.

The sound-emitting unit 15 outputs sounds. The vibrator 16 informs a user of an incoming call by vibrating.

The memory 17 includes a flash memory or the like. The memory 17 can be used to save setting information input by the user. The memory 17 may also include a group registering area 17a. The group registering area 17a can be used to store at least one telephone number corresponding to a group.

The group registering area 17a can also be used to register a group address. Assigning the group address, the user can send a message to a plurality of end units, e.g., cellular phones, using a single input command.

The controller 18 may include a CPU, ROM and RAM. The controller 18 can be configured to control all components of the communication apparatus.

The controller 18 has a general processor that controls voice communication or text message communication with a communication terminal through a communication network. It will be appreciated that the network may be any public or private network, whether a wide or local area network. In an illustrative implementation, the network is a mobile communication network, which may be connected to the Internet.

The controller 18 further has an undelivered message detector 18a and undelivered address register 18b and group address setting unit 18c.

The control station in a network (e.g., an MSC in a cellular network) associated with the communication apparatus informs the communication apparatus (e.g., a cellular phone) by sending through a base station an alert message that a message sent by the communication apparatus went undelivered. That is, the alert message indicates that the control station was unable to deliver the message that the communication apparatus requested to be sent.

The undelivered message detector 18a detects the alert message from data inputted from the CDMA signal processors 6. The alert message includes the addresses to which the message could not be delivered. The addresses may include, but are not limited to, telephone numbers, IP addresses and other network addresses.

The undelivered address register 18b registers all undelivered addresses in the registering area 17a as an undelivered address group.

When a user assigns a group registered in the group registering area 17a as a message delivery address, the group address setting unit 18c sets all addresses that belong to the assigned group.

Next, a procedure of registering an undelivered address group and using the undelivered address group in the communication apparatus will be described.

A description of the procedure of voice communication or text message communication in the communication apparatus is omitted as the procedure is the same as that in the conventional communication apparatus.

A communication apparatus in this exemplary embodiment has two modes in which an undelivered address group may be registered. One mode is the auto-registering mode that automatically registers an undelivered-address group in the group registering area 17a.

The other mode is the user-registering mode in which the user registers an undelivered-address group. The user can select one of the two modes of operation in advance.

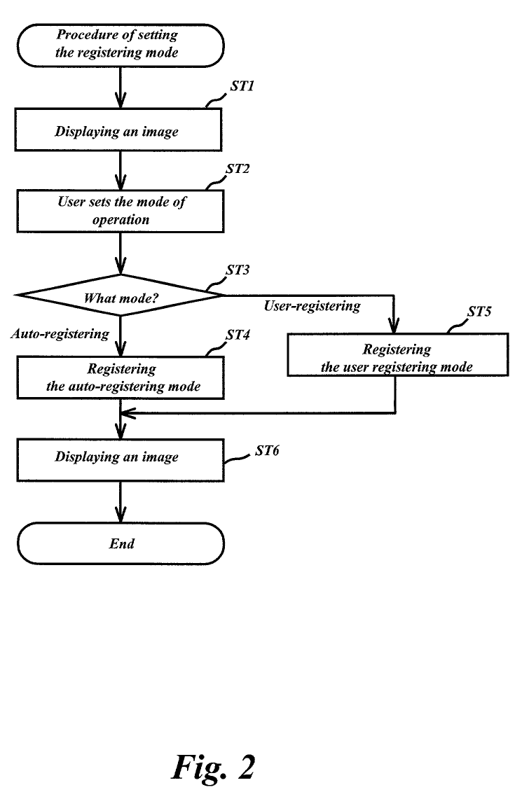

An illustrative procedure of setting the registering mode is described in FIG. 2. The controller 18 may control the setting procedure.

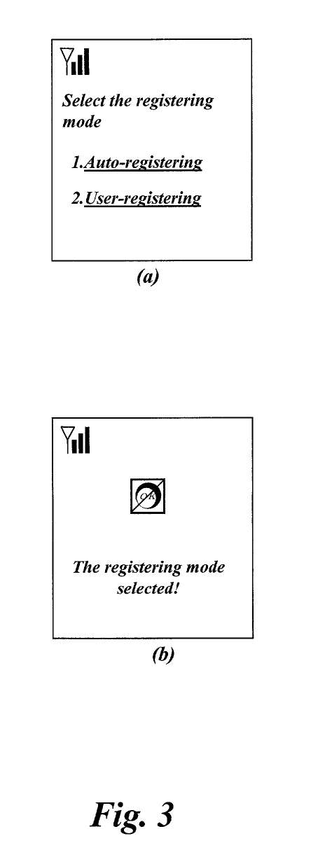

In the setting procedure in FIG. 2, the controller 18 assigns LCD 13 to display an image depicted in FIG. 3(a) requesting the user to set the mode for operation (ST1).

The controller 18 accepts the user setting of the registering mode (ST2) and then detects the registering mode set by the user (ST3).

When the user sets the mode to an auto-registering mode, the controller 18 uses the auto-registering mode to register an undelivered address group in the memory 17 (ST4).

When the user sets the mode to a user-registering mode, the controller 18 uses the user-registering mode as the registering mode to register an undelivered address group in the memory 17 (ST5).

After completing ST4 or ST5, the controller 18 assigns the LCD 13 to display the image depicted in FIG. 3(b) informing the user of the registering mode (ST6).

The controller 18 assigns the LCD 13 to display the image for a period (for example, 2 -seconds). After displaying the image, the controller 18 terminates this setting procedure.

When the control station cannot deliver a message to a communication terminal to which the communication apparatus requests delivery, the control station generates an alert message to inform the communication apparatus that the message did not get delivered to the communication terminal(s).

The alert message can be usually included in control data received from the control station in the communication network. The CDMA signal processor 6 detects the control data. The detected control data is inputted into the controller 18. The controller 18 analyzes the inputted control data.

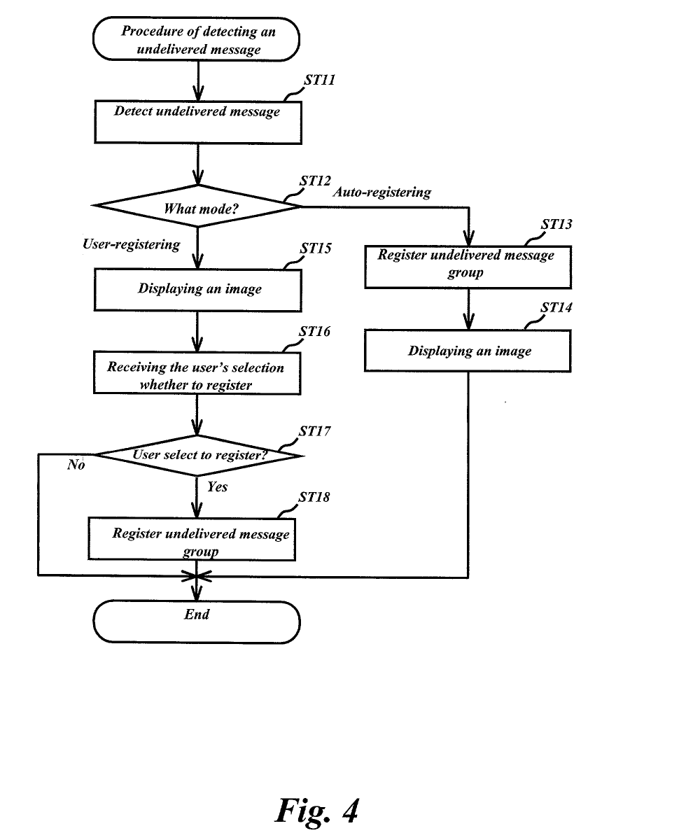

When the control data includes an alert message, the controller 18 executes a procedure for detecting an undelivered message, for example as described in FIG. 4.

In the illustrative procedure shown in FIG. 4, the controller 18 detects an undelivered message by detecting the alert message in the control data received from the control station in the communication network (ST11).

The controller 18 then detects what registering mode has been set to register an undelivered address group in the memory 17 (ST12).

When the auto-registering mode has been set, the controller 18 automatically registers an undelivered address group in the group registering area 17a (ST13).

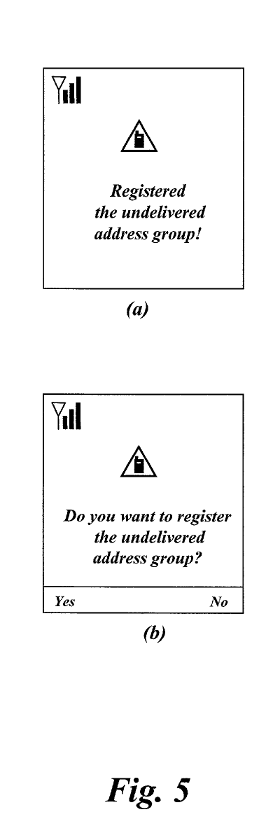

After registering the undelivered address group, the controller 18 assigns the LCD 13 to display the image depicted in FIG. 5(a) to inform the user that the registering operation has been completed (ST14).

The controller 18 assigns the LCD 13 to display the image for a period (for example, 2 seconds). After displaying the image, the controller 18 terminates this procedure.

When a user-registering mode has been set (ST12), the controller 18 assigns the LCD 13 to display the image depicted in FIG. 5(b) asking the user whether she desires to register the undelivered address group in the group registering area 17a (ST15).

The controller 18 receives or detects the user's selection whether to register (ST16) and analyzes the received or detected selection and determines whether the user desires to register the undelivered address group (ST17).

When the operator selects registering, the controller 18 registers the undelivered address group. After registering the group, this procedure is terminated.

When the operator does not select registering, this procedure is terminated without registering the undelivered address group.

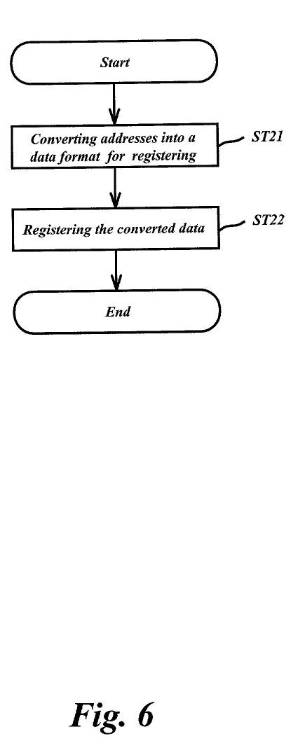

In the ST13 or the ST18 described in FIG. 4, the controller 18 carries out a procedure to register the undelivered address group such as described in FIG. 6.

In the procedure described in FIG. 6, the controller 18 detects the requested addresses to which the control station could not deliver the message. After detecting the requested addresses, the controller 18 may convert the addresses into a data format for registering in the group registering area 17a (ST21).

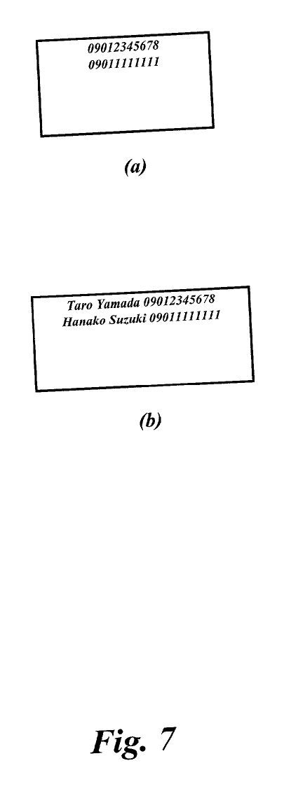

Specifically, the controller 18 detects the addresses included in an undelivered message such as the addresses shown in FIG. 7(a). Each of the addresses indicates a telephone number or other address (e.g., email address) to which the control station could not deliver the message. After detecting the addresses, the controller 18 may look up a name or other information corresponding to each respective address stored in an address (e.g., telephone) directory. The directory can be in the memory 17. The controller can convert the detected addresses into data including the corresponding name described in FIG. 7(b) or other corresponding information (e.g., a picture of the intended recipient of the message).

The controller 18 registers the converted data as an undelivered group address in the group registering area 17a in the memory 17 (ST22).

As described above, a communication apparatus in this embodiment registers an undelivered group address based on an alert message received from the control station in the communication network.

By registering the address received from the control station for which a message went undelivered to a single group for delivery, a user can easily attempt redelivery of the message.

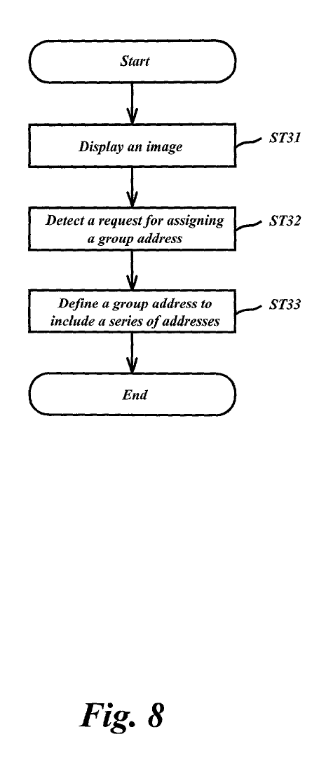

After accepting a request for assigning a group address to addresses for delivering a message, the controller 18 can carry out a procedure of selecting a group address for delivery as described in FIG. 8.

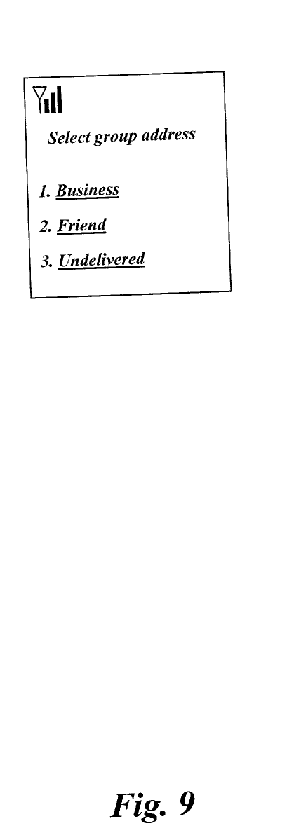

In the procedure of FIG. 8, the controller 18 displays an illustrative image on the LCD 13 for requesting a user to assign a group address to a message to be sent (ST31). The image is depicted in FIG. 9.

After displaying the image, the controller 18 detects a user request for assigning a group address (ST32). When the controller 18 detects the user request, the controller 18 defines a group address to include a series of address to which a single message will be delivered (ST33).

A group of addresses to which a message went undelivered may be assigned a group address for redelivering the message.

As described above, when a user sets the addresses in the alert message received from the control station to a group address, the user only sets an undelivered group address. Using the present invention, the operation required to set the addresses in an undelivered message can be reduced.

When the registering mode is set as the auto-registering mode in the communication apparatus, the addresses included in the alert message are registered automatically as an undelivered group address in the group registering area 17a in the memory 17. In this mode, the user does not have to spend much time to register an undelivered group address.

When the registering mode is set as the user-registering mode in the communication apparatus, addresses included in the alert message is registered only when the user decides to register them. In this mode, although it takes time to register the addresses, a user need only register desired undelivered addresses and does not have to register undesired undelivered addresses in the group registering area 17a in the memory 17.

According to this embodiment, the user can select an auto-registering mode or a user-selecting mode, the user can register the undelivered group address, as desired.

According to this embodiment, an undelivered group address can be registered for delivering a message to a plurality of addresses. The undelivered group address can be registered in the group registering area 17a. A procedure of setting an undelivered group address is the same as that of setting a group address in other circumstances.

The invention is not limited to the embodiment discussed above. For example, in the mobile communication network to which a communication apparatus belongs, not only a text message but also a voice message or a video message may be sent. In this case, the control station can send an alert message to the communication apparatus indicating that the voice or video message went undelivered.

Also, the invention is applicable to not only a radio communication apparatus but to any message communication apparatus that communicates text message, voice, video or multimedia messages such as personal data assistants (PDA).

According to one embodiment, a user can select between an auto-registering mode and an operator-selecting mode. In alternative embodiment, the mode in the communication apparatus may be predetermined, for example in the manufacture of the communication apparatus.

In another implementation of the invention, the undelivered group address can be registered in another memory or memory area different from the group registering area 17a. In this way, separating the undelivered group address from other group addresses can minimize user confusion.

The communication apparatus can store in memory a message identifier, such as a number, received from the control station and assigned to an undelivered message. The message identifier provides an indication as to the time the message was sent relative to the time another undelivered message was sent. The message identifier can assist a user in determining the order in which multiple undelivered messages were sent.

Although the invention has been defined using the appended claims, these claims are exemplary in that the invention may be intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

What is claimed is:

1. A communication apparatus for use in a communication network including a plurality of communication apparatuses, the communication apparatus comprising:
a transmitter configured to transmit a message to said plurality of communication apparatuses;
a receiver configured to receive an alert message identifying communication apparatuses to which the message went undelivered;
a detector configured to detect addresses of the communication terminals from the received alert message;
a memory configured to store the detected addresses as a group address.

2. The communication apparatus according to 1, further comprising a setting unit configured to set the stored group address as a message delivery address.

3. The communication apparatus according to the claim 1, wherein the memory is configured to automatically store the detected addresses.

4. The communication apparatus according to the claim 1, wherein memory configured to store the addresses response to a user input.

5. A method of storing a group address in the communication apparatus for use in a communication network including a plurality of communication apparatuses, the method comprising:
transmitting a message to said plurality of communication apparatuses;
receiving an alert message identifying communication apparatuses to which the message went undelivered;
detecting addresses of the communication apparatuses from the received alert message; and
storing the detected addresses as a group address.

6. The method according to claim 5, further comprising setting the stored group address as a message delivery address.

7. The method according to the claim 5, wherein the storing includes automatically storing the detected addresses.

8. The method according to the claims 5, wherein the storing includes storing the detected addresses response to a user input.

9. A controller in a communication apparatus for use in a communication network including a plurality of communication apparatuses, the controller comprising:
a transmitter configured to transmit a message to said plurality of communication apparatuses;
a receiver configured to receive an alert message identifying communication apparatuses to which the message went undelivered;
a detector configured to detect addresses of the communication apparatuses from the received alert message;
a register configured to store the detected addresses as a group address.

10. The controller according to claim 9, further comprising a setting unit configured to set the stored group address as a message delivery address.

11. The controller according to the claim 9, wherein the register is configured to automatically register the detected addresses.

12. The controller according to the claim 9, wherein register is configured to store the detected addresses response to a user input.
